(19) United States
(12) Patent Application Publication
(10) Pub. No.: US 2011/0036190 A1
(43) Pub. Date: Feb. 17, 2011

(54) Driving mechanism of a steering wheel

(75) Inventors: Hui-Hui HUANG, Tainan Hsien (TW); Wen Ru TSENG, Tainan Hsien (TW)

Correspondence Address: BACON & THOMAS, PLLC, 625 SLATERS LANE, FOURTH FLOOR, ALEXANDRIA, VA, 22314-1176, US

(73) Assignee: Aeon Motor Co., Ltd., Tainan Hsien (TW)

(21) Appl. No.: 12/461,559

(22) Filed: Aug. 17, 2009

(51) Int. Cl. F16H 1/10

(52) U.S. Cl. 74/413

(57) ABSTRACT

A driving mechanism of a steering wheel includes a sector gear driven by a gear shaft to rotate on a gear shaft linked together with the sector gear, and a displacement plate having one end fixed with the gear plate shaft and another end pivotally connected with two directional pull rods that are further connected with a directional joint of two front wheels respectively. When a steering wheel is turned left or right, the gear shaft is to be rotated to simultaneously drive the sector gear and the gear shaft to turn around, so that the displacement plate, the directional pull rods, the directional joints and the front wheels can be concurrently driven to undertake an angular displacement for changing a car's direction. Thus, the driving mechanism of the invention has a relatively small size, with cost lowered as well.

### BACKGROUND OF THE INVENTION

1. Field of the Invention

This invention relates to a driving mechanism of a steering wheel, particularly to one having its size relatively shrunk and its cost cut down.

2. Description of the Prior Art

Commonly, a steering wheel is designed with a proper gear ratio so that it can be operated by a driver with saved strength. A conventional driving mechanism of a steering wheel is always based on a rack engaged with a worm. In order to provide enough displacement of the worm, the rack has to be rather long. However, with such rather bulky components assembled together, the driving mechanism has definitely a huge dimension with a high cost.

### SUMMARY OF THE INVENTION

The object of this invention is to offer a novel driving mechanism of a steering wheel, not only with its size shrunk but also with cost lowered.

The driving mechanism of a steering wheel includes a sector gear driven by a gear shaft connected with a steer wheel to rotate on a gear shaft linked together with the sector gear, and a displacement plate having one end fixed with one end of the gear shaft and another end pivotally connected with two directional pull rods that are further connected with a directional joint of two front wheels respectively. When a steering wheel is turned left or right, the gear shaft is to be rotated to simultaneously drive the sector gear and the gear shaft to turn around, so that the displacement plate, the directional pull rods, the directional joints and the front wheels can be concurrently driven to undertake an angular displacement for changing a car's direction. Thus, the driving mechanism of the invention has a relatively small size, with cost lowered.

### BRIEF DESCRIPTION OF DRAWINGS

This invention is better understood by referring to the accompanying drawings, wherein:

FIG. 1 is a perspective view of a preferred embodiment of a driving mechanism of a steering wheel in the present invention, showing it being assembled between two front wheels of a car;

FIG. 2 is a perspective view of the preferred embodiment of the driving mechanism of a steering wheel in the present invention;

FIG. 3 is an exploded perspective view of the preferred embodiment of the driving mechanism of a steering wheel in the present invention;

FIG. 4 is a top view of the preferred embodiment of the driving mechanism of a steering wheel in the present invention;

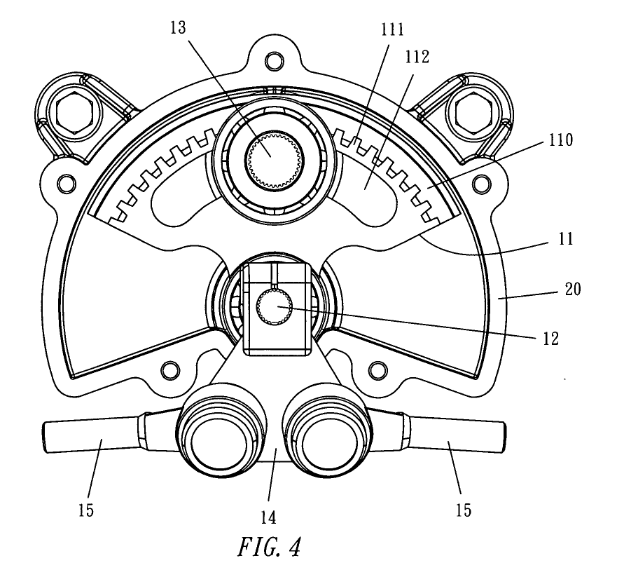

FIG. 5 is a top view of the preferred embodiment of the driving mechanism of a steering wheel in the present invention, showing it being operated to make a turn (left); and

FIG. 6 is a top view of the preferred embodiment of the driving mechanism of a steering wheel in the present invention, showing it being operated to make a turn (right).

### DETAILED DESCRIPTION OF THE PREFERRED EMBODIMENT

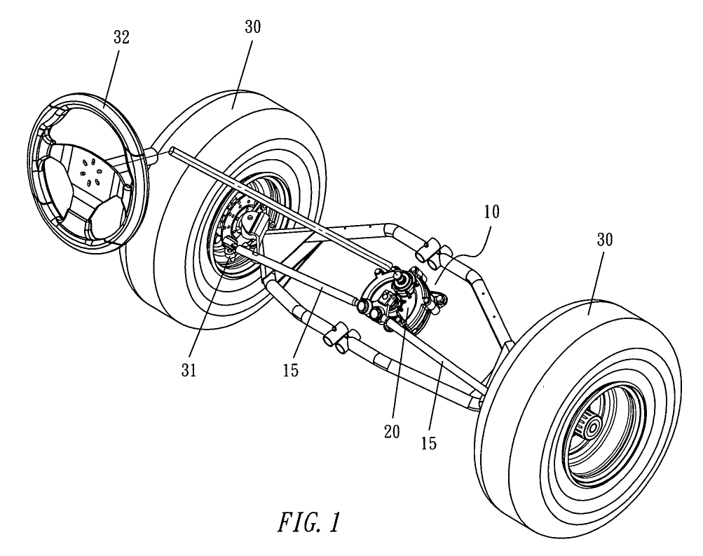

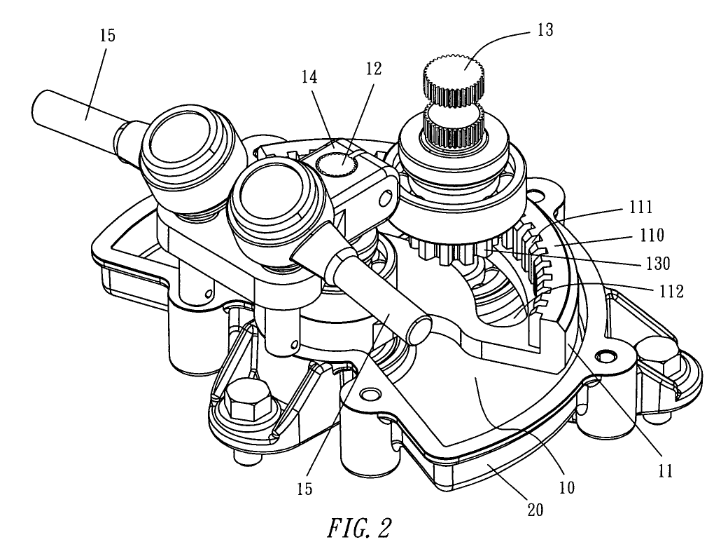

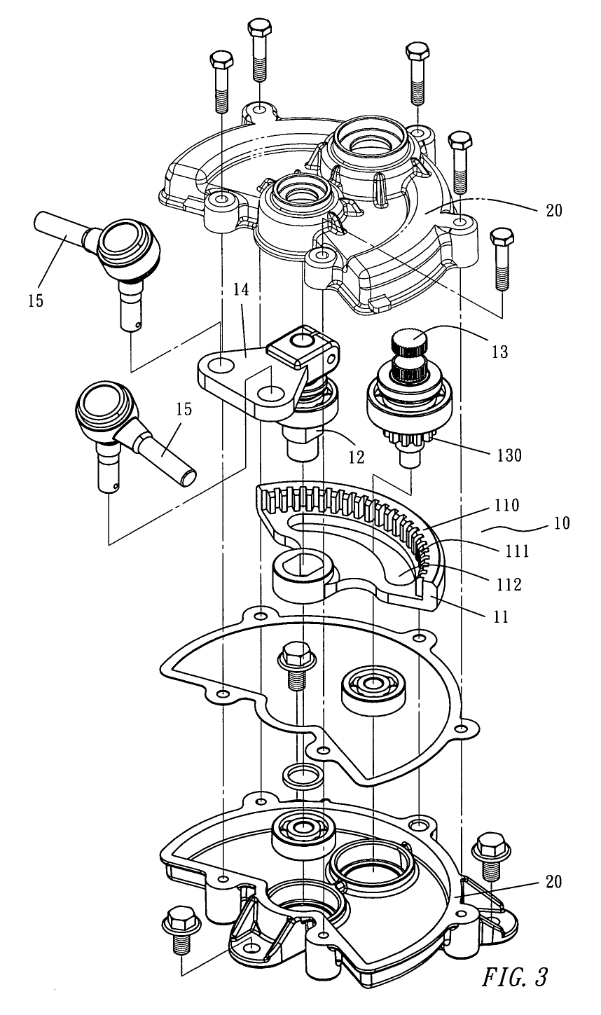

As shown in FIGS. 1-3, a preferred embodiment of a driving mechanism 10 of a steering wheel in the present invention is installed between two front wheels 30 and covered by two hoods 20, including a sector gear 11, a gear shaft 13 and a displacement plate 14.

The sector gear 11 is supported by and linked together with a gear shaft 12, provided with a sector projection 110 extended around the outer circumference, plural sector gear teeth 111 formed in the inner wall of the sector projection 110, and an arc-shaped groove 112 sharing the same center of the gear shaft 12.

The gear shaft 13 is vertically fitted in the arc-shaped groove 112, provided with a gear 130 located around the bottom for engaging with the sector gear teeth 111. With the top end of the gear shaft 13 combined with a steering wheel 32, the gear shaft 13 is controlled by the steering wheel 32 to revolve on its own axis, as shown in FIG. 1.

The displacement plate 14 has one end fixed with one end of the gear shaft 12 and another end pivotally connected with two directional pull rods 15 properly spaced apart. Each of the directional pull rods 15 is further extended out of the hoods 20 to connect with a directional joint 31 of the front wheels 30, as shown in FIG. 1.

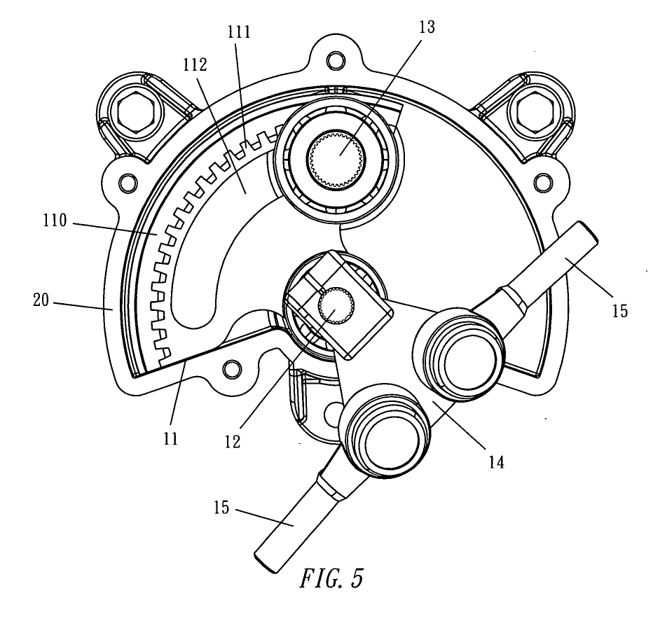

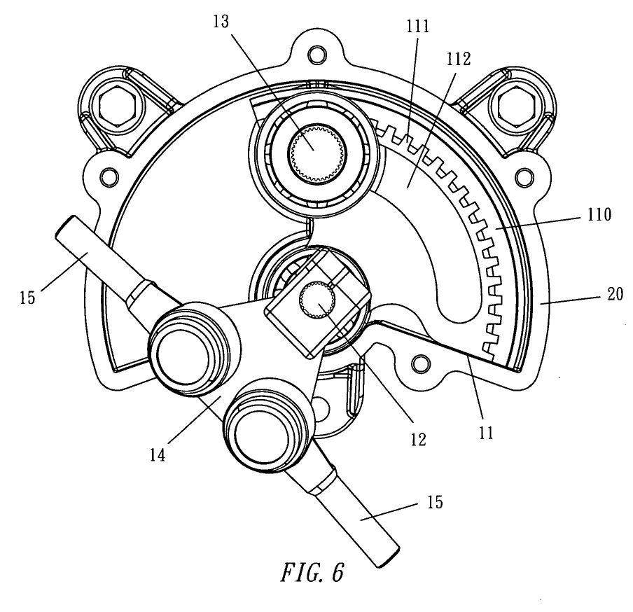

In using, when the steering wheel 32 is turned left or right, the gear shaft 13 and the gear 130 are to be driven to revolve on its own axis. As the sector gear teeth 111 of the sector gear 11 is engaged with the gear 130, the sector gear 11 and the gear shaft 12 are also to be driven by the gear shaft 13 to simultaneously move, enabling the displacement plate 14 to move as well. By the time, the directional pull rods 15 are to be moved to enable the directional joint 31 of the front wheels 30 to move so that the front wheels 30 can alter their traveling direction, as shown in FIGS. 5 and 6.

With the sector gear 11, the gear shaft 12, the gear shaft 13 and the displacement plate 14 assembled together, the driving mechanism 10 of the invention has a relatively small size and low cost.

While the preferred embodiment of the invention has been described above, it will be recognized and understood that various modifications may be made therein and the appended claims are intended to cover all such modifications that may fall within the spirit and scope of the invention.

What is claimed is:

1. A driving mechanism of a steering wheel comprising:
a sector gear supported by and linked together with a gear shaft, said sector gear provided with plural sector gear teeth formed along an inner wall of an outer circumference;
a gear shaft provided with a gear formed around a bottom for engaging with said sector gear teeth, said gear shaft having one end combined with a steering wheel and controlled by said steer wheel to revolve on its own axis; and
a displacement plate having one end fixed with one end of said gear shaft and another end pivotally connected with two directional pull rods properly spaced apart, each of said directional pull rods further connected with a directional joint of two front wheels respectively.

2. The driving mechanism of a steer wheel as claimed in claim 1, wherein said sector gear is provided with an arc-shaped groove that shares a same center of said gear shaft and is to be fitted through by said gear shaft.

3. The driving mechanism of a steer wheel as claimed in claim 2, wherein said sector gear is provided with a sector projection extended around an outer circumference, said sector gear teeth formed in an inner wall of said sector projection.
